(19) United States
(12) Patent Application Publication
(10) Pub. No.: US 2022/0269764 A1
(43) Pub. Date: Aug. 25, 2022

(54) MOBILE OPTICAL VIEW ENVIRONMENT

(71) Applicant: Booz Allen Hamilton Inc., McLean, VA (US)

(72) Inventor: Gary Jason Myers, McLean, VA (US)

(73) Assignee: Booz Allen Hamilton Inc., McLean, VA (US)

(21) Appl. No.: 17/680,106

(22) Filed: Feb. 24, 2022

Related U.S. Application Data
(60) Provisional application No. 63/153,883, filed on Feb. 25, 2021.

(51) Int. Cl. G06F 21/32; G06F 1/3231

(52) U.S. Cl. CPC G06F 21/32; G06F 1/3231

(57) ABSTRACT

Techniques are disclosed for managing a device. The techniques include determining whether a user is detected based on one or more authentication devices or one or more persistent presence monitors; and based on the result of the detection, allowing or denying access to the device.

### CROSS-REFERENCE TO RELATED APPLICATIONS

This application claims priority to pending U.S. Provisional Patent Application No. 63/153,883, entitled “MOBILE OPTICAL VIEW ENVIRONMENT,” filed on Feb. 25, 2021, the entirety of which is hereby incorporated herein by reference.

### BACKGROUND

Controlling the permissions for use of computing devices is important in many areas of industry and government. Improvements in techniques for controlling such permissions are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of a secure computing system, according to an example;

FIG. 3 illustrates an example implementation of the device;

FIG. 4 is a flow diagram of a method for operating a secure device, according to an example; and

FIG. 5 is a flow diagram of a method for operating a secure device according to another example.

### DETAILED DESCRIPTION

Techniques are disclosed for managing a device. The techniques include determining whether a user is detected based on one or more authentication devices or one or more persistent presence monitors; and based on the result of the detection, allowing or denying access to the device.

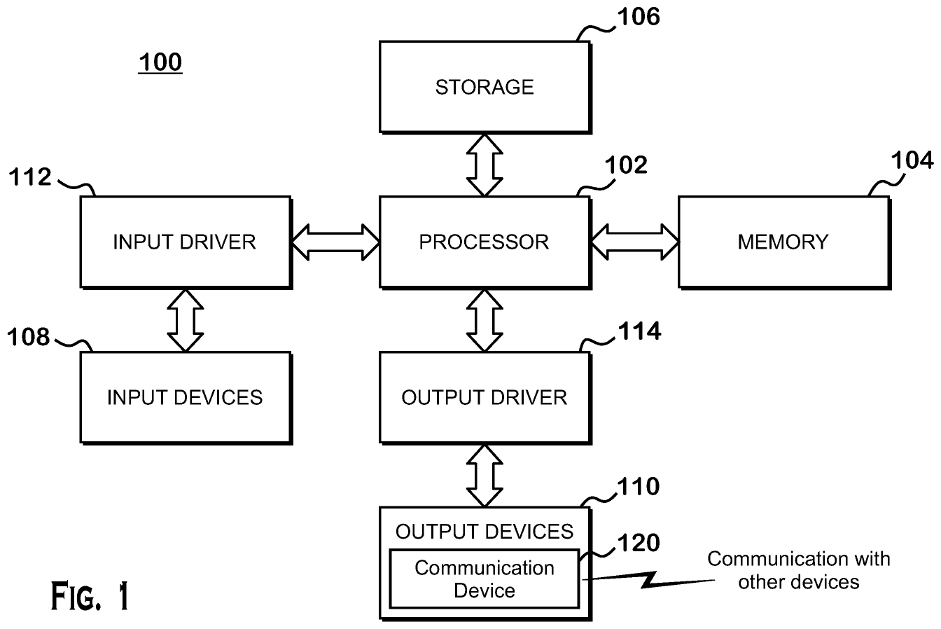

FIG. 1 is a block diagram of an example device 100 in which one or more features of the disclosure can be implemented. The device 100 could be one of, but is not limited to, for example, a computer, a gaming device, a handheld device, a set-top box, a television, a mobile phone, a tablet computer, or other computing device. The device 100 includes a processor 102, a memory 104, a storage 106, one or more input devices 108, and one or more output devices 110. The device 100 also includes one or more input drivers 112 and one or more output drivers 114. Any of the input drivers 112 are embodied as hardware, a combination of hardware and software, or software, and serve the purpose of controlling input devices 108 (e.g., controlling operation, receiving inputs from, and providing data to input drivers 112). Similarly, any of the output drivers 114 are embodied as hardware, a combination of hardware and software, or software, and serve the purpose of controlling output devices (e.g., controlling operation, receiving inputs from, and providing data to output drivers 114). It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, without limitation, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 and output driver 114 include one or more hardware, software, and/or firmware components that are configured to interface with and drive input devices 108 and output devices 110, respectively. The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110.

The output devices 110 include a communication device 120. The communication device includes one or both of a wired or wireless electronic communication device for communicating with one or more other electronic devices. Examples of such communications devices include wired local area network (“LAN”) devices, wireless LAN devices, cellular devices, or other communication devices.

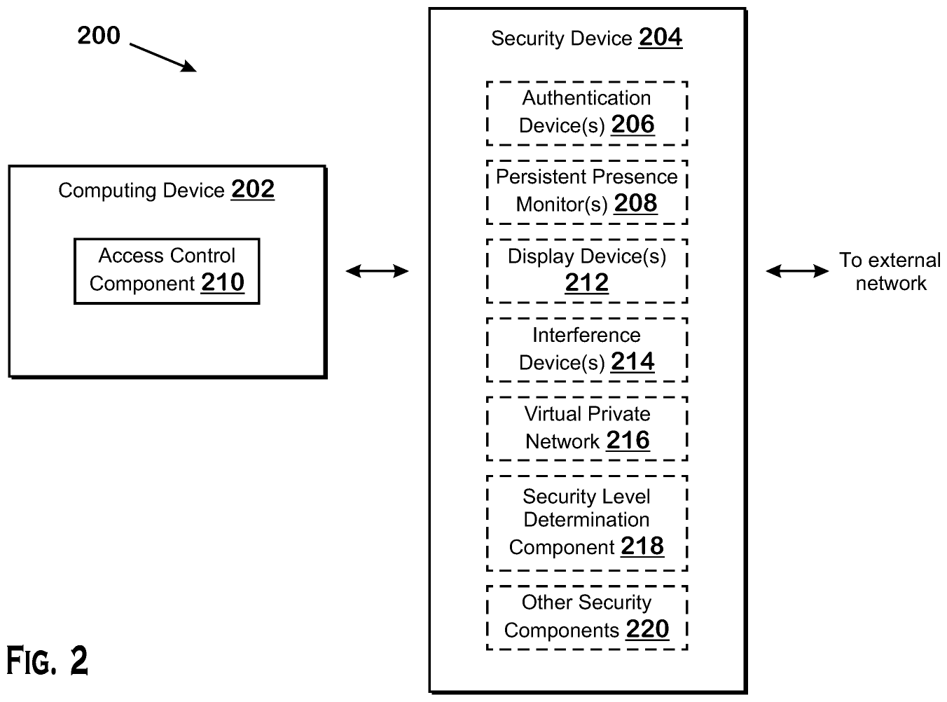

FIG. 2 is a block diagram of a secure computing system 200, according to an example. The secure computing system 200 includes a computing device 202 and a security device 204. In some examples, the security device 204 has a virtual reality headset form factor. In other examples, the security device 204 has a different form factor. In some examples, the computing device 202 is a traditional computing device, such as a laptop, a desktop computer, a phone, or a tablet. In some examples, the computing device 202 is integrated within, or is a part of, the security device 204. In other words, some examples of the secure computing system include a single device that includes the components of both the computing device 202 and the security device 204. In such examples, it is not necessary that both the computing device 202 and security device 204 include separate individual components of the components of the device 100 illustrated in FIG. 1. For example, a single processor 102 may perform functions for both the computing device and the security device 204. In addition, in some examples, the secure computing system 200 is a thin client, in that the secure computing system 200 includes software or hardware for connecting to a remote desktop through networking capabilities that are protected by the virtual private network 216.

Either or both of the computing device 202 and the security device 204 are implemented as versions of the device 100 of FIG. 1. In other words, either or both of the computing device 202 and the security device 204 include a processor 102, memory 104, storage 106, input devices 108, and output devices 110. In examples where the computing device 202 and security device 204 are a single device, the secure computing system 200 would include a processor 102, memory 104, storage 106, input devices 108, and output devices 110, each of which performs associated functionality for the computing device 202 and security device 204.

The security device 204 provides access control functionality to the computing device 202. To this end, the security device 204 includes one or more entities that detect whether the secure computing system 200 is being used in a permitted manner, and controls the computing device 202 based on this detection. An access control component 210 permits or denies access to the secure computing system 200 based on these entities. The access control component 210 is software executing on a processor (e.g., the processor 102), hardware circuitry, or a combination of software executing on a processor and hardware circuitry.

To perform this detection functionality, the security device 204 includes one or more of one or more authentication devices 206 and one or more persistent presence monitors 208. In various examples, the security device 204 includes any combination of the security devices 204 and the authentication devices 206. In some examples, the security device 204 includes one or more authentication devices 206 and one or more presence monitors 208. In some examples, the security device 204 includes one or more authentication devices 206 but not one or more presence monitors 208. In some examples, the security device 204 includes one or more presence monitors 208 but not one or more authentication devices 206. The phrase “determining whether a user is detected” is sometimes used herein to refer to the determination of whether the one or more authentication devices 206 and/or the one or more presence monitors 208 indicate that a user is present and is using the device 204 in a permitted manner. Various techniques for making such a determination are included herein along with the discussion of the authentication devices 206 and presence monitors 208. In some examples, the access control component 210 makes the determination of whether a user is detected based on these techniques.

Some examples of authentication devices 206 include a fingerprint sensor, an iris sensor, and an optical heart rate monitor. In use, the access control component 210 uses a fingerprint sensor to determine the identity of a user. In use, the access control component 210 uses an iris scanner to scan the iris of a user to determine the identity of a user. In use, the access control component 210 uses an optical heart rate monitor to identify a user based on heart rate patterns.

The authentication devices 206 are configured to authenticate a user to the secure computing system 200. More specifically, the secure computing system 200 determines, based on one or more measurements taken by one or more authentication devices 206, whether the secure computing system 200 is permitted to be used. In some examples, the measurements taken with the one or more authentication devices 206 include measurements associated with a user.

The presence monitors 208 are configured to determine presence of a user in the vicinity of the secure computing system 200. More specifically, the secure computing system 200 (e.g., the access control component 210) determines, based on one or more measurements taken by one or more presence monitors 208, whether the secure computing system 200 detects a user. In some examples, the measurements taken with the one or more presence monitors 208 include measurements associated with a user.

Some examples of presence monitors 208 include an optical heart rate monitor, a pressure senor, a temporal temperature sensor, and a proximity detection sensor. In some examples, the proximity detection sensor comprises a sensor that detect proximity of a user. Any technology can be used to detect presence, such as technologies based on electrical detection, electromagnetic detection, acoustic detection, or any other type of proximity detector that detects proximity of a user. In use, the access control component 210 controls the optical heart rate monitor to detect a heart rate. In some examples, the access control component 210 determines that a user is present if the heart rate monitor detects a valid heart rate and determines that a user is not present if the heart rate monitor does not detect a valid heart rate. In use, the access control component 210 controls the pressure sensor to detect the presence of a user. In some examples, the access control component 210 determines that a user is present if sufficient pressure is applied to the pressure sensor and determines that a user is not present if insufficient pressure is applied to the pressure sensor. In use, the access control component 210 controls the temporal temperature sensor to detect the presence of a user. In some examples, the access control component 210 determines that a user is present if the temperature sensor senses a temperature consistent with a user and determines that a user is not present if the temperature sensor senses a temperature inconsistent with a user.

The access control component 210 of the computing device 202 is an element of the computing device 202 that controls communication with the security device 204 and controls the computing device 202 based on the measurements taken with the security device 204. In various examples, the access control component 210 either allows the computing device 202 to operate normally in the event that the measurements from the security device 204 indicate that a user is present and authenticated, or controls the computing device 202 to shut down in the event that measurements from the security device 204 indicate that no user is present or that a user is present but is not authenticated. In some examples, in the event that no user is present or a user is present but is not authenticated, the access control component 210 encrypts some or all contents of storage or memory of the computing device 202, in addition to also shutting down the computing device 202. In some examples, in the event that no user is present or a user is present but is not authenticated, the access control component 210 causes the security device 204 to shut down. In some examples, determining that a user is detected includes determining that a user is present, that a user is authenticated, or that a user is present and authenticated.

In some examples, the security device 204 includes a display device 212. The display device displays information such as graphics generated by the computing device 202. In some examples, the security device 204 includes one or more interference devices 214. The one or more interference devices 214 perform actions that interfere with surveillance or recording of output from the security device 204. In an example, an interference device 214 generates electromagnetic radiation that interferes with the ability of an optical recording device such as a camera to record what is shown on the display device 212. In an example, such an interference device 214 is an infrared emitter.

In some examples, the security device 204 includes a virtual private network 216. The virtual private network provides the computing device 202 with a secure interface into a remote network (the “private network”). More specifically, local networks—networks internal to an organization—typically provide enhanced accessibility features for devices on that network. For example, a local network may allow access to one or more resources, such as data, files, or the like, whereas devices that are not on that local network are not allowed to access such resources. The virtual private network 216 provides the computing device 202 with “virtual” access to a local network that is remote from the computing device 202. In various examples, the virtual private network 216 is a software component that executes on a processor of the security device 204, a hardware circuitry component of the security device 204, or a combination of a software component that executes on a processor of the security device 204 and a hardware circuitry component of the security device 204.

The security level determination component 218 is a component of the security device 204 that controls the level of access given to the computing device 202 to resources based on credentials of a user of the computing device 202. In some examples, the resources are data or software of a network that is remote to the secure computing system 200. In some examples, these credentials are determined based on activity of the authentication device 206. In an example, the authentication devices 206 include an iris scanner that scans a user's iris and determines the identification of the user based on that scan. The access control component 210 generates or fetches credentials for that user in response to the scan and provides those credentials to an external system. The security level determination component 218 permits access to resources associated with that user.

In some examples, the security device 204 includes one or more other security components 220. In various examples, the one or more other security components 220 include one or more secure cryptoprocessor (such as a trusted platform module (“TPM”)), or a TEMPEST shielding, (“Telecommunications Electronics Materials Protected from Emanating Spurious Transmissions”). The cryptoprocessor is configured to perform function such as encrypting cryptographic keys, encrypting certificates for a virtual private networks, and encrypting passwords. The TEMPEST shielding is a form of physical shielding that protects against attacks that, by detecting various types of emanations from the secure computing system 200, are able to discern information that is intended to be private.

In some examples, the access control component 210 accesses one or more communications devices 120 to determine whether the secure computing system 200 is operating in a permitted location. In various examples, the communications devices 120 include one or more of a global positioning system (“GPS”) module, a Bluetooth transceiver, a wireless network module, or a cellular communication module. In various examples, the access control component 210 controls one or more of the communications devices 120 to determine whether the secure computing system 200 is operating in a permitted location. In some examples, the access control component 210 disables access to the secure computing system 200 in the event that the access control component 210 determines that the secure computing system 200 is not in a location where the secure computing system 200 is permitted to be operated and does not disable access to the secure computing system 200 in the event that the access control component 210 determines that the device is in a location in which the secure computing system 200 is permitted to be operated.

As described above, the access control component 210 utilizes the one or more authentication devices 206 and/or the one or more persistent presence monitors 208 to determine whether access to the secure computing system 200 is permitted (also sometimes referred to herein as “whether a user is detected”). Some additional details for some example implementations are now provided.

In an example, the secure computing system 200 begins powered off. In an example, the device 200 has not yet been booted into an operating system. A user powers the secure computing system 200 on (e.g., requesting the secure computing system 200 to boot), and the access control component 210 performs one or more checks based on one or more of the one or more authentication devices 206 and the one or more persistent presence monitors 208. If any of the checks fail, then the access control component 210 causes the computing device 202 to power down without booting into the operating system. If all of the checks succeed, then the access control component 210 causes the computing device 202 to boot into the operating system.

For authentication devices 206, a check succeeds in the situation that the access control component 210 verifies that the data received from the authentication device 206 (e.g., a detected fingerprint or a detected heartbeat pattern) is in agreement with a user that is permitted to use the secure computing system 200. A check fails in the situation that the access control component 210 determines that the data is not associated with a known user or is associated with a user that is not permitted to use the secure computing system 200. In some implementations, the access control component 210 verifies that the data received from all authentication devices 206 indicates the same user, and further verifies that this user is the user whose credentials are entered manually (such as a user name and password supplied via a keyboard or other input device).

For persistent presence monitors 208, a check involves determining whether the input received indicates the presence of a user. In the situation that input from one or more persistent presence monitors 208 indicates that a user is present, the access control component 210 determines that the check succeeds. In the situation that input from one or more persistent presence monitors 208 indicates that a user is not present, the access control component 210 determines that the check fails In an example, for a pressure sensor, the access control component 210 determines whether the presence sensor senses sufficient pressure to indicate that a body part (e.g., head) of a user is present. For the heartrate monitor, the access control component 210 determines whether the heartrate monitor detects a heartrate consistent with a user. For a temporal temperature sensor, the access control component 210 determines whether the temporal temperature sensor detects a temperature consistent with a user.

In some examples, the access control component 210 determines that a user is present in the situation that input from all persistent presence monitors 208 indicates that a user is present and determines that a user is not present in the situation that input from at least one persistent presence monitors 208 indicates that a user is not present. In some examples, the access control component 210 determines that a user is present in the case that input from at least some of the persistent presence monitors 208 indicates that a user is present and determines that a user is not present in the case that input from all of the persistent presence monitors 208 indicates that a user is not present.

In some examples, the access control component 210 encrypts one or both of the hard drive and other non-volatile memory in the situation that the secure computing system 200 becomes powered down (e.g., shut off completely or placed into a standby mode). In such examples, when the device is powered on and the access control component 210 authenticates a user and determines that a user is present, the access control component decrypts the hard drive and non-volatile memory for use by the user. In some examples, the access control component 210 additionally or alternatively connects the secure computing system 200 to one or more secure networks, through, for example, the virtual private network 216.

In some implementations, during use, the access control component 210 continuously or periodically monitors one or more of the authentication devices 206 and the persistent presence monitors 208. In some examples, in the situation that the access control component 210 determines that a user is not present or that a user that is not authenticated to the device is present (collectively, that “an authenticated user is not present”), the access control component 210 disables the device 200. In some examples, disabling the device 200 includes one or more of locking the device or shutting down the device. In some examples, disabling the secure computing system 200 also includes encrypting the hard drive and/or other non-volatile media. In some examples, this encryption occurs a threshold amount of time after the access control component 210 first determines that an authenticated user is not present. In some examples, if the device is locked but the access control component 210 again detects that an authenticated user is present via one or more of the persistent presence monitors 208 and the one or more authentication devices 206, the access control component 210 unlocks the device. In situations where the hard drive and/or other non-volatile media is encrypted, unlocking the device includes decrypting that media. Locking the device means disabling access to normal operation of the device such as access to applications or the operating system, and unlocking the device means resorting access to those items.

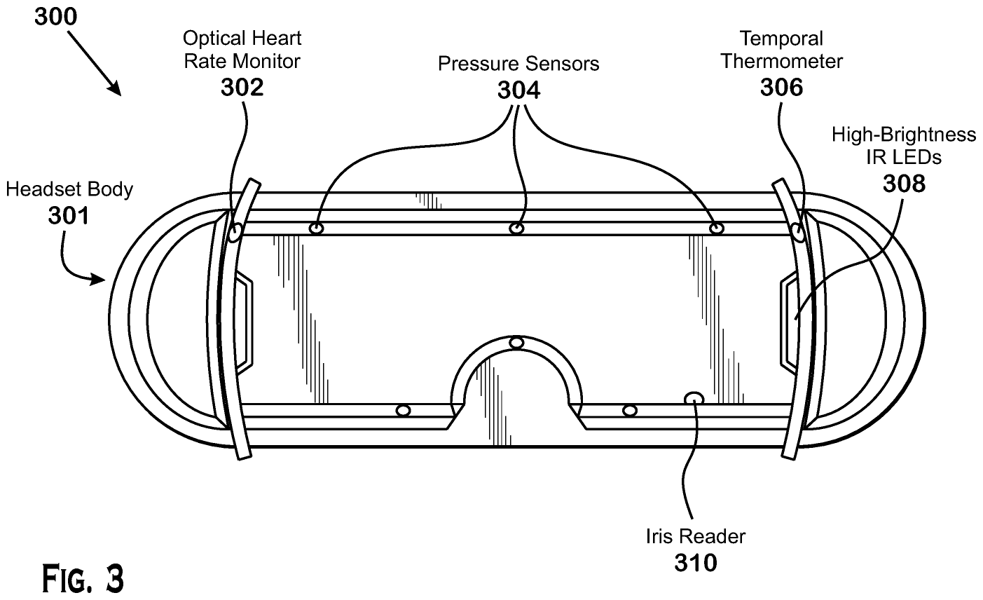

FIG. 3 illustrates an example implementation of the secure computing system 200. As shown, an example security device 300, which is the example implementation of the secure computing system 200, includes a virtual reality headset body 301. This body 301 includes various components not shown, such as components of the device 100 of FIG. 1. In addition, the body 301 includes an optical heart rate monitor 302 positioned on the top left portion of the view area, that serves as an authentication device 206 and a persistent presence monitor 208. The body 301 also includes several pressure sensors 304 arrayed at the top of the view area that serve as persistent presence monitor 208. The body 301 also includes a temporal thermometer 306, on the top right portion of the view area, that serves as a persistent present monitor 208. The body 301 also includes an iris reader 310 that serves as an authentication device 206. It should be understood that although an example composition of a secure computing system 200 is illustrated, a wide variety of form factors and component combinations are possible.

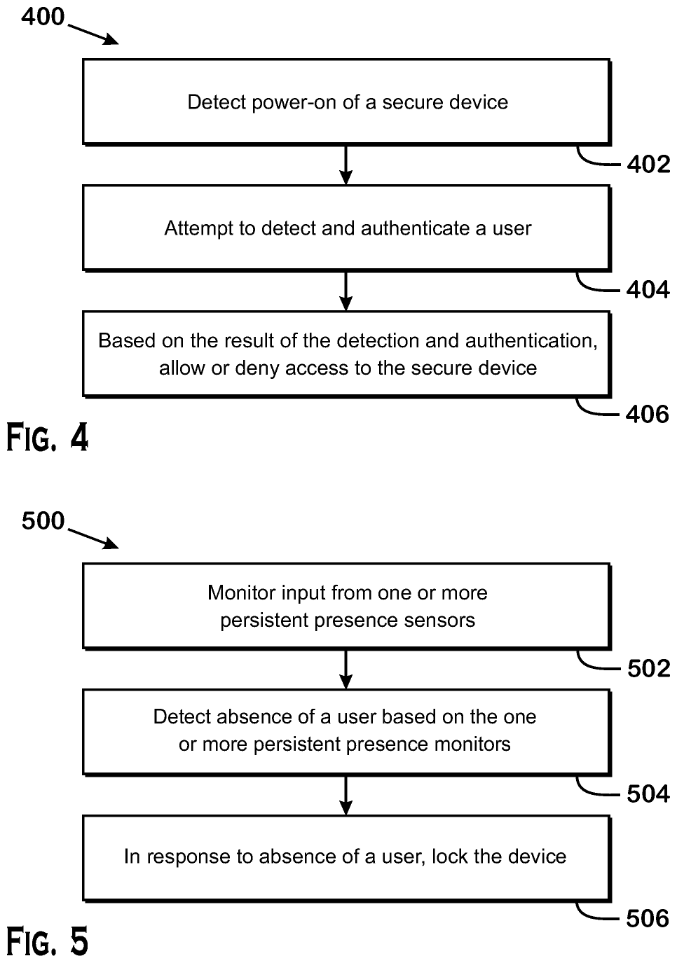

FIG. 4 is a flow diagram of a method 400 for operating a secure computing system 200, according to an example. Although described with respect to the system of FIGS. 1-3, those of skill in the art will understand that any system, configured to perform the steps of the method 400 in any technically feasible order, falls within the scope of the present disclosure.

The method 400 begins at step 402, where the access control component 210 detects the power-on of a secure computing system 200. In various examples, powering on the secure computing system 200 includes flipping a switch or hitting a button to power the secure computing system 200 on while the device is off, or waking the device from standby.

At step 404, in response to the power-on, the access control component 210 attempts to authenticate and validate a user. Various techniques for authenticating and validating a user are described herein. In general, the access control component 210 attempts to authenticate the user based on input from one or more authentication devices 206, attempts to detect presence of a user via input from the one or more persistent presence monitors 208, or both attempts to the user and attempts to detect presence of the user. It should be understood that implementations of the secure computing system 200 include implementations in which either persistent presence monitors 208 are absent or authentication devices 206 are absent. In either of these situations, step 404 does not include performing the operations associated with those items.

At step 406, the access control component 210 allows or denies access to the secure computing system 200 based on the result of step 404. Various examples in which this step is performed are described above. In some implementations, in the situation that the access control component 210 authenticates the same user with all authentication devices 206 and detects presence of a user with all persistent presence monitors 208, the access control component 210 allows access to the device. In the situation that the access control component 210 does not authenticate the same user with all authentication devices 206 or does not detect presence of a user with all persistent presence monitors 208, the access control component 210 denies access to the device. In other implementations, if some but not all of authentication devices 206 authenticate the same user or some but not all persistent presence monitors 208 detect a user, the access control component 210 allows access to the secure computing system 200. If no authentication device 206 authenticates the same user or no persistent presence monitors 208 detect presence of a user, the access control component 210 denies access to the device.

In various examples, allowing access means allowing a user to use the device 20 normally, by, for example, allowing the operating system and application to execute normally, presenting graphics displayed by software to the display device 212, accepting input from one or more input devices, and/or providing output via one or more output devices. In addition, in implementations in which the access control component 210 encrypts the hard drive when the secure computing system 200 becomes inactive, allowing access to the secure computing system 200 includes decrypting the hard drive.

In various examples, denying access to the secure computing system 200 includes locking the device, which includes preventing access to operations of the operating system and applications. In some examples, denying access to the secure computing system 200 also includes encrypting the hard drive and/or other non-volatile memories.

FIG. 5 is a flow diagram of a method 500 for operating a secure computing system 200 according to another example. Although described with respect to the system of FIGS. 1-3, those of skill in the art will understand that any system, configured to perform the steps of the method 500 in any technically feasible order, falls within the scope of the present disclosure.

The method 500 begins at step 502, where the access control component 210 monitors input from one or more persistent presence monitors 208. Monitoring these monitors 208 includes receiving input from the monitors 208 and attempting to determine whether the input indicates presence or absence of a user.

At step 504, the access control component 210 detects the absence of a user via the one or more persistent presence monitors 208. This operation is described in additional detail herein. In general, the access control component 210 interprets input received from one or more persistent presence monitors 208 to determine whether the input indicates that a user is present. In some implementations, if all persistent presence monitors 208 indicate that a user is present, then the access control component 210 determines that user is present, and if at least one persistent presence monitors 208 indicates that the user is not present, then the access control component 210 determines that a user is not present. In other implementations, if at least some (at least a threshold number) persistent presence monitors 208 indicate that a user is present, then the access control component 210 determines that the user is present, and if no persistent presence monitors 208, or too few (lower than the threshold number) persistent presence monitors 208 indicate that a user is present, then the access control component 210 determines that the user is not present.

At step 506, in response to a determination that a user is absent, the access control component 210 locks the secure computing system 200. In an example, locking the device prevents access to the normal operations of the secure computing system 200, including most of the operating system functions and application functions. In some examples, the access control component 210 encrypts the hard drive and/or other non-volatile memory in response to detecting that an authenticated user is no longer present. In some examples, the access control component 210 encrypts the hard drive and/or other non-volatile memory a period of time after detecting that an authenticated user is no longer present.

In this locked state, the access control component 210 monitors for a user returning to the device. Specifically, the access control component 210 examines input received from the persistent presence monitors 208, and/or authentication devices 206 to determine whether an authenticated user is present. If an authenticated user is present, then the access control component 210 unlocks the device.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a graphics processor, a machine learning processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for managing a device, the method comprising:
determining whether a user is detected based on one or more authentication devices or one or more persistent presence monitors; and
based on the determining, allowing or denying access to the device.

2. The method of claim 1, wherein:
the determining is performed in response to detecting power-on of the device.

3. The method of claim 1, wherein the determining includes determining whether a user is present based on the one or more persistent presence monitors, by determining whether input from the persistent presence monitors is consistent with a user being present.

4. The method of claim 1, wherein the determining includes determining whether a user is present based on the one or more authentication devices by determining whether input from the one or more authentication devices is consistent with credentials of a user.

5. The method of claim 1, wherein the one or more persistent presence monitors include one or more of an optical heart rate monitor, a pressure sensor, a proximity detection sensor, and a temporal temperature sensor.

6. The method of claim 1, wherein the one or more authentication devices includes one or more of a fingerprint sensor, an iris sensor, and an optical heart rate monitor.

7. The method of claim 1, wherein allowing or denying access to the device includes:
in response to one or more persistent presence sensors indicating that a user is not present, or in response to one or more authentication devices indicating that a user is not authenticated, performing one or more of locking the device, disabling network access for the device, and encrypting data of the device until presence of the user is detected and the user is reauthenticated.

8. The method of claim 1, wherein allowing or denying access to the device includes:
in response to all persistent presence sensors indicating that a user is present and all authentication devices indicating that a user is authenticated, allowing access to the device.

9. The method of claim 1, further comprising:
operating an electromagnetic radiation emitter to interfere with recording of output of a display device of the device.

10. A device, comprising:
one or more security devices, including either or both of an authentication device and a persistent presence monitor; and
an access control component, configured to:
determine whether a user is detected based on the one or more security devices; and
based on the determining, allow or deny access to the device.

11. The device of claim 10, wherein:
the determining is performed in response to detecting power-on of the device.

12. The device of claim 10, wherein the determining includes attempting to detect a user based on the one or more persistent presence monitors, by determining whether input from the persistent presence monitors is consistent with a user being present.

13. The device of claim 10, wherein the determining includes determining whether a user is present based on the one or more authentication devices by determining whether input from the one or more authentication devices is consistent with credentials of a user.

14. The device of claim 10, wherein the one or more persistent presence monitors includes one or more of an optical heart rate monitor, a pressure sensor, a proximity detection sensor, and a temporal temperature sensor.

15. The device of claim 10, wherein the one or more authentication devices includes one or more of a finger print sensor, an iris sensor, and an optical heart rate monitor.

16. The device of claim 10, wherein allowing or denying access to the device includes:
in response to one or more persistent presence sensors indicating that a user is not present, or in response to one or more authentication devices indicating that a user is not authenticated, performing one or more of locking the device, disabling network access for the device, and encrypting data of the device until presence of the user is detected and the user is reauthenticated.

17. The device of claim 10, wherein allowing or denying access to the device includes:
in response to all persistent presence sensors indicating that a user is present and all authentication devices indicating that a user is authenticated, allowing access to the device.

18. The device of claim 10, wherein the access control component is further configured to operate an electromagnetic radiation emitter to interfere with recording of output of a display device of the device.

19. A non-transitory computer-readable medium storing instructions that, when executed by a processor, cause the processor to:
determine whether a user is detected based on one or more authentication devices or one or more persistent presence monitors; and
based on the determining, allow or deny access to the device.

20. The non-transitory computer-readable medium of claim 19, wherein:
the determining is performed in response to detecting power-on of the device.

21. The non-transitory computer-readable medium of claim 19, wherein the determining includes determining whether a user is present based on the one or more persistent presence monitors, by determining whether input from the persistent presence monitors is consistent with a user being present.

22. The non-transitory computer-readable medium of claim 19, wherein the determining includes determining whether a user is present based on the one or more authentication devices by determining whether input from the one or more authentication devices is consistent with credentials of a user.

23. The non-transitory computer-readable medium of claim 19, wherein the one or more persistent presence monitors includes one or more of an optical heart rate monitor, a pressure sensor, and a temporal temperature sensor.

24. The non-transitory computer-readable medium of claim 19, wherein the one or more authentication devices includes one or more of a finger print sensor, an iris sensor, and an optical heart rate monitor.

25. The non-transitory computer-readable medium of claim 19, wherein allowing or denying access to the device includes:
in response to one or more persistent presence sensors indicating that a user is not present, or in response to one or more authentication devices indicating that a user is not authenticated, locking the device.

26. The non-transitory computer-readable medium of claim 19, wherein allowing or denying access to the device includes:
in response to all persistent presence sensors indicating that a user is present and all authentication devices indicating that a user is authenticated, allowing access to the device.

27. The non-transitory computer-readable medium of claim 19, wherein the instructions further cause the processor to:
operate an electromagnetic radiation emitter to interfere with recording of output of a display device of the device.
